(19) United States
(12) Patent Application Publication
(10) Pub. No.: US 2012/0234158 A1
(43) Pub. Date: Sep. 20, 2012

(54) AUTO-SYNCHRONOUS VOCAL HARMONIZER

(75) Inventors: Yaozhu Paul Chan, Singapore (SG); Minghui Dong, Singapore (SG); Ling Cen, Singapore (SG); Siu Wa Lee, Singapore (SG)

(73) Assignee: Agency for Science, Technology and Research

(21) Appl. No.: 13/418,236

(22) Filed: Mar. 12, 2012

(30) Foreign Application Priority Data
Mar. 15, 2011 (SG) 201101825-6

(51) Int. Cl. G10H 7/00

(52) U.S. Cl. 84/622

(57) ABSTRACT

A harmony synthesizer is described for harmonizing vocal signals. The harmony synthesizer performing a method comprising receiving an input vocal signal; identifying a pitch trace of the vocal signal; aligning the harmonization interval vector(s) to the pitch trace of the vocal input signal to form an aligned harmonization pitch trace; and synthesizing harmonization vocals according to the aligned harmonization pitch trace.

This application claims priority to Singapore Patent Application No. 201101825-6, filed Mar. 15, 2011.

### FIELD OF THE INVENTION

Embodiments of the invention generally relate to a vocal harmonizer and a method for performing vocal harmonization.

### BACKGROUND OF THE INVENTION

The term vocal harmony may refer to melodic lines that are to be sung consonant to the lead vocals. This carries the accompaniment to the latter, which carries the main melody. The term “vocal harmony” may be used interchangeably with the term “accompaniment” in this disclosure.

The correct addition of vocal harmony can significantly enhance the way an unaccompanied lead melody sounds. Furthermore, the exposed imperfections of an unaccompanied vocal lead may be transformed into pleasant sounding features when an accompaniment is added to it. One illustration of this, for example, is the way harmonic phase discrepancies between lead and accompaniment vocals translate into perceived amplitude and frequency variations that are perceived to be interesting to the human ear. This is one of the reasons why vocal harmony is so popular in the production of commercial music. However, unlike lead melodies, vocal accompaniment melodies are often difficult for most people to learn. It is not uncommon even for professional singers to have to spend time rehearsing beforehand. This inspired a variety of vocal harmony synthesis methods.

Believed to be originating from the Gregorian Chants, a traditional method, referred to as 458, for the derivation of the harmony line (accompaniment melody) from the lead vocal line is by indiscriminately using perfect 4^{th} or 5^{th} or octave (8^{ve}) intervals. Perfect 4^{th} and 5^{th} intervals, however, in contemporary music, introduces potential dissonances with the 4^{th} and 7^{th} notes in the most common major scale, which are undesirably sharpened and flattened, respectively. In the minor scale, they can introduce a variety of dissonances, depending on the type of minor scale. Octave intervals do not introduce such dissonances since they are a special case of harmony, where all the overtones of both the notes are completely aligned. However, this produces an effect very similar to perfect unison, which hardly achieves the effect of harmony.

Reported improvement to this method, referred to as 458-II, partially corrects this problem with the requirement of user specification of the song key. This information, allows for use of the major and minor 3^{rd} intervals. However, even as clashes with the introduction of notes outside the natural key are resolved, clashes with notes within the key cannot be resolved this way.

Vocoders have been popular in music production since the 1970s, especially for the generation of robot-like vocals. The Electro-HarmonixVoicebox is one such vocoder and uses an instrumental (for example, a guitar) input as the carrier and the human voice as a modulator to generate vocal harmony. In this arrangement, referred to as AUX, the singer and instrumentalist (ideally, the same person) are tasked with the job of synchronization, eliminating the need for the machine to perform alignment. However, the harmony input requirements make this more applicable to trained musicians and unsuitable for singers without any special music ability.

The current solutions, for example, Kageyama's Karaoke Apparatus and Antare's Harmony Engine (in Chord by MIDI Track mode), use more advanced re-synthesis techniques. However, there is no input instrument, and the singer is required to synchronize with a metronome or the backing track. Antare's Harmony Engine is more of a tool for song producers or sound engineers, so synchronization usually requires manual correction after recording. Kageyama's Karaoke Apparatus sets forth to tailor to subjects who do not have to be very musically inclined, but requires them to be able to have some sense of rhythm, that is, to be able to sing in time (manually synchronize) with the backing track.

### SUMMARY OF THE INVENTION

In one embodiment, a method for harmonizing vocal signals is provided. A harmony synthesizer performing a method comprising receiving an input vocal signal; identifying a pitch trace of the vocal signal; aligning a number of harmonization interval vector(s) to the pitch trace of the vocal input signal to form an aligned harmonization pitch trace; and synthesizing harmonization vocals according to the aligned harmonization pitch trace.

According to another embodiment, a system for harmonizing vocal signals according to the method described above is provided.

### SHORT DESCRIPTION OF THE FIGURES

Illustrative embodiments of the invention are explained below with reference to the drawings.

FIG. 1 is a harmony synthesizer in accordance with an embodiment.

FIG. 2 is a flowchart for harmonizing vocal signals in accordance with an embodiment.

FIG. 3 is a flowchart for harmonizing vocal signals in accordance with an embodiment.

FIG. 4 is a chart of Key and Note Values Determination in accordance with an embodiment.

FIG. 5 is a diagram of re-synthesis.

FIG. 6 is the first stanza of the contents of a MIDI sequence.

FIG. 7 compares the midi pitch trace with that of the interpretation of the sung vocal lead.

FIG. 8 shows the pitch trace raw and after the interpretation stage.

FIG. 9 shows an alignment of the Interpreted and MIDI pitch traces.

FIG. 10 is a comparison of spectrogram plots.

### DETAILED DESCRIPTION

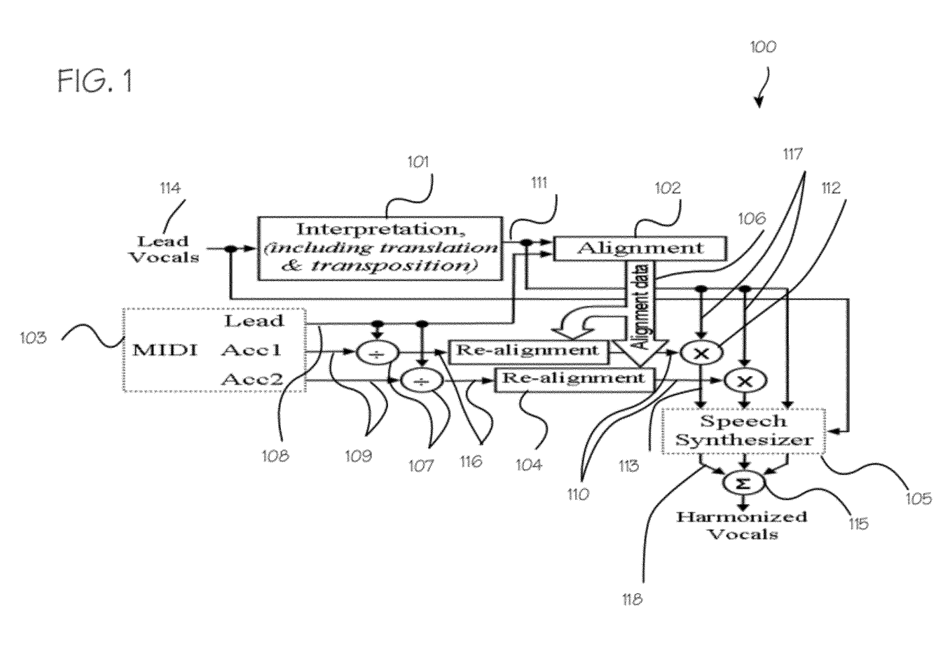

FIG. 1 is a harmony synthesizer in accordance with an embodiment.

The harmony synthesizer 100 includes an interpretation unit 101, an alignment unit 102, a MIDI unit 103, re-alignment units 104, and speech synthesizer 105.

The interpretation unit 101 may be configured to receive an input of lead vocals 114 to derive a pitch trace. The input of lead vocals 114 may also be referred to as an input of the vocal signals or lead vocal input. The vocal signals may be an analog signal.

In one embodiment, the interpretation 111 of the pitch trace of the lead vocal input 114 is aligned with the Lead MIDI pitch trace 108 from the MIDI unit 103.

Then, the alignment data 106 is used to re-align the MIDI interval trace 116 at re-alignment units 104, which are derived 107 from the relationship between the MIDI lead 108 and accompaniment tracks 109.

After which, the re-aligned MIDI interval trace 110 is now synchronized with the interpretation 117 of the lead vocal input and the vectors may be added 112 to derive the target pitch trace 113 for synthesizing the vocal accompaniments (harmonization vocals).

The target pitch traces 113 are fed into a high quality voice synthesizer (speech synthesizer 105), together with the original lead vocal input 114, which may be re-synthesized or directly added to the harmonized signal (depending on whether pitch-correction is desired). In signal processing, the term “synthesize” describes what is created.

The outputs of the synthesis stage are weighted differently and summed 115 into two separate channels to get stereophonic harmonized vocals. Reverberation may be further applied to the final output for spatial depth.

The various embodiments provide that vocal harmony is synthesized from lead vocals without the requirement of an auxiliary instrument or synchronization with a backing track, effectively achieving “A Capella” vocals from solo lead vocals. The harmony information may be required, but may be in the form of a MIDI file. Synchronization may be performed automatically using the reliable pitch synchronization method described here. This may eliminate the need for manual synchronization or input of harmony information, making this more suitable for non-musicians.

The various embodiments also provide systems and methods for the automatic synthesis of vocal harmony. The embodiments of this disclosure recognize and take into account that existing innovations either allow for dissonances (i.e. non-harmonious or clashing intervals) at various locations or require some musical ability of the user.

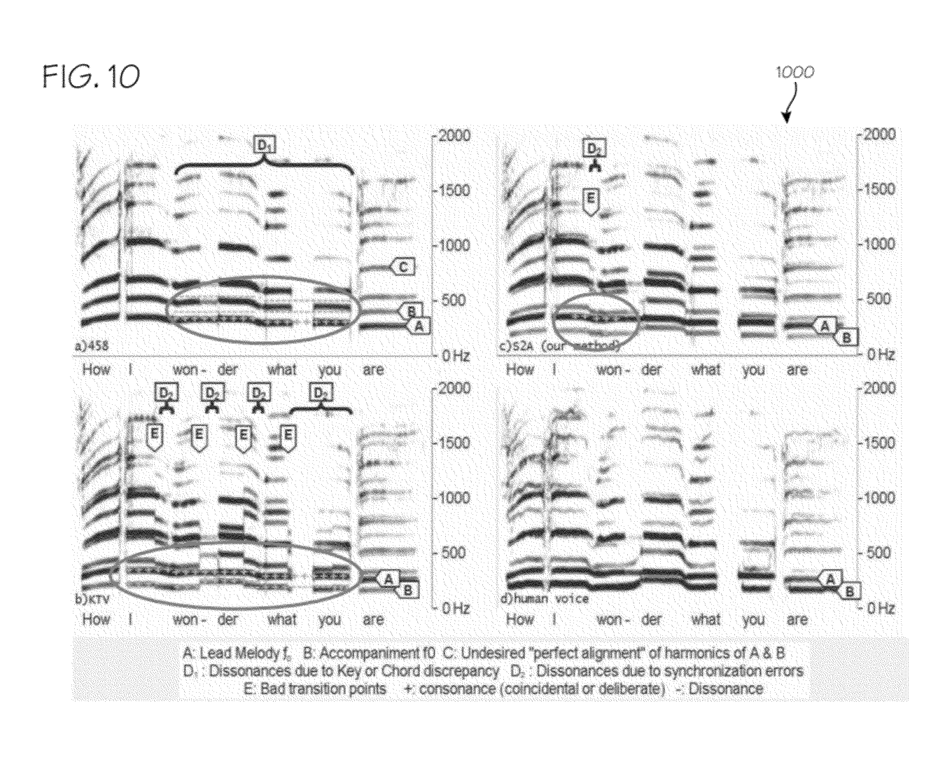

The embodiments of this disclosure provide a method that is able to automatically synthesize vocal harmony even for ordinary singers with a poor sense of harmony and rhythm. The method has been evaluated by means of a spectrogram comparison, as shown in FIG. 10, as well as subjective listening tests. A spectrogram comparison of this method and two popular existing methods against that of the human voice shows that this method is least dissonant and most similar to natural human vocals. Subjective listening tests conducted separately for experts and non-experts in the field confirm that the vocal harmony synthesized using this method sounds the best in terms of consonance, inter-syllable transition, as well as naturalness and appeal.

According to an embodiment, a harmony synthesizer is provided for harmonizing vocal signals. The harmony synthesizer comprising an interpretation unit 101 configured to receive an input of the vocal signal 114 and identify a pitch trace of the vocal signals (interpretation 111 of the pitch trace); an alignment unit 102 may be configured to align a number of harmonization interval vector(s) (MIDI interval trace 116) of harmonization signals to the pitch trace 111 of the vocal signals; and a speech synthesizer 105 configured to re-synthesize the vocal signal 114 according to the aligned harmonization pitch (target pitch traces 113).

According to an embodiment, the alignment unit is further configured to align a reference pitch trace (MIDI pitch trace 108) to the pitch trace of the vocal signals to form a synchronized pitch trace (alignment data 106); and align a number of accompaniment pitch intervals (MIDI interval trace 116) to the interpreted pitch trace 111 to form a number of synchronized accompaniment pitch traces 113.

According to an embodiment, the speech synthesizer is further configured to synthesize the number of vocal signals according to the synchronized accompaniment pitch traces 113.

According to an embodiment, the accompaniment pitch intervals are based on a relationship between the reference pitch trace and the number of accompaniment pitch traces.

According to an embodiment, the reference pitch trace is from a MIDI signal.

According to an embodiment, the accompaniment pitch traces are from MIDI signals.

According to an embodiment, the interpretation unit is further configured to identify an autocorrelation of the vocal signals. In other embodiments, the pitch trace may be derived by a variety of other methods.

According to an embodiment, the interpretation unit is further configured to correct voiced and unvoiced speech misinterpretations for the pitch trace. The interpretation unit further corrects octave misinterpretations and translates the pitch trace into a linear scale.

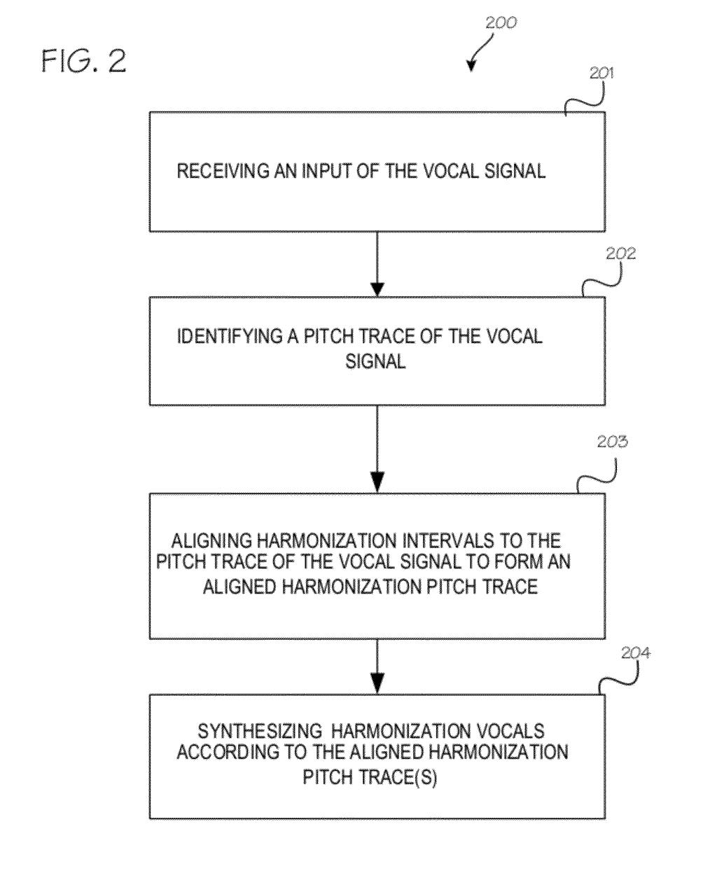

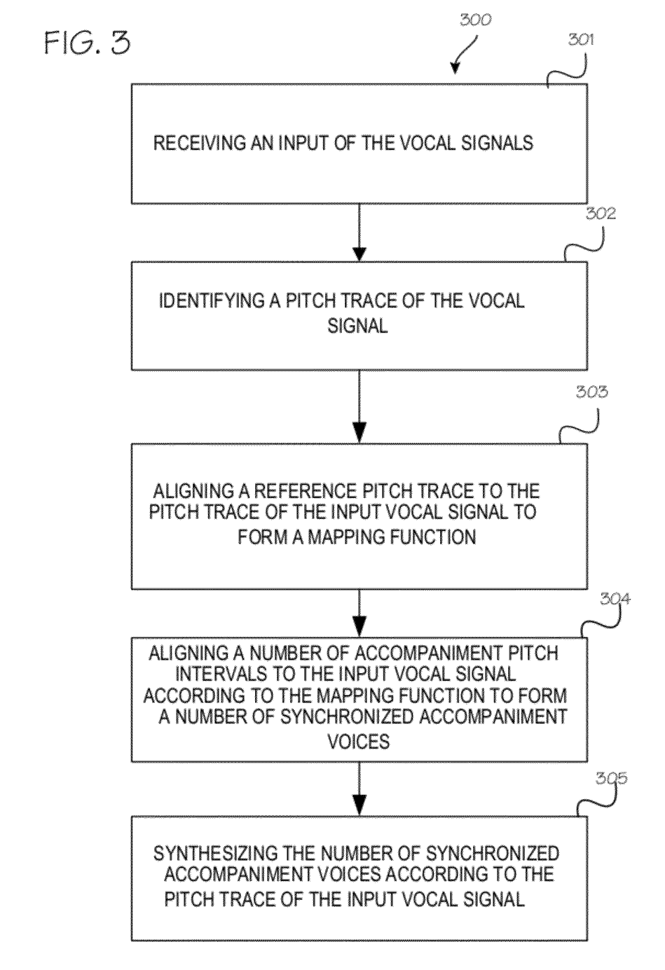

The harmony synthesizer 100 for example carries out a method as illustrated in FIGS. 2 and 3.

FIG. 2 is a flowchart for harmonizing vocal signals in accordance with an embodiment.

The process 200 illustrates a method for harmonizing vocal signals.

STEP 201: Receiving an input of the vocal signal 114.

STEP 202: Identifying a pitch trace 111 of the vocal signal.

STEP 203: Aligning a pitch interval 116 of harmonization signals to the pitch trace 111 of the vocal signal.

STEP 204: Synthesizing harmonization vocals 118 according to the aligned harmonization pitch trace(s) 113.

FIG. 3 is a flowchart for harmonizing vocal signals in accordance with an embodiment.

The process 300 illustrates a method for harmonizing vocal signals.

STEP 301: Receiving an input of the vocal signal.

STEP 302: Identifying a pitch trace of the vocal signal.

STEP 303: Aligning a reference pitch trace to the pitch trace of the input vocal signal to form a mapping function.

STEP 304: Aligning a number of accompaniment pitch intervals to the input vocal signal according to the mapping function.

STEP 305: Synthesizing the number of synchronized accompaniment voices according to the harmonization pitch trace.

According to an embodiment, a method is provided for harmonizing vocal signals. The method comprising: receiving an input signal of the vocals; identifying a pitch trace of the vocal signals; aligning a pitch interval of harmonization signals to the pitch trace of the vocal signals; and synthesizing harmonization vocals according to the aligned harmonization pitch trace.

According to an embodiment, aligning the trace of harmonization interval to the pitch trace of the vocal signals comprises: aligning a reference pitch trace to the pitch trace of the input vocal signal to form a mapping function; aligning a number of accompaniment pitch intervals according to the mapping function to form a number of synchronized accompaniment pitch intervals; and superimposing the synchronized accompaniment pitch intervals onto the pitch trace of the input vocal signal to form a number of synchronized accompaniment pitch traces.

According to an embodiment, synthesizing the vocal signals to the harmonization signals comprises synthesizing the number of synchronized accompaniment vocals according to their pitch traces, by means of re-synthesizing the input vocal signal.

According to an embodiment, the number of accompaniment pitch intervals are based on a relationship between the reference pitch trace and the number of accompaniment pitch traces.

According to an embodiment, the reference pitch trace is from a MIDI signal.

According to an embodiment, the accompaniment pitch traces are from MIDI signals.

According to an embodiment, identifying the pitch trace of the vocal signals comprises translating to a MIDI Note-Number Scale using the formula:

$${n}_{midi - scale} = 9 + ( 12 {log}_{2} ( {f}_{Hz} \times \frac{32}{440} ) )$$

where f_{Hz} is frequency in Hz.

According to an embodiment, identifying the pitch trace of the vocal signals comprises estimating an overall tuning drift for the pitch trace. (Fine tune adjustment).

According to an embodiment, identifying the pitch trace of the vocal signals comprises identifying a frequency of occurrence for each note of the pitch trace; weighting each note differently for each possible key; and identifying a probable key for each note based on the weighted notes.(Key Prediction).

According to an embodiment, identifying the pitch trace of the vocal signals comprises adjusting an accidental note of the pitch trace to a nearest note within a key of the pitch trace. (Note correction).

TABLE 1
Comparison of current Automatic Harmony Synthesis
methods against an illustrative embodiment.

| | How existing methods compare with the proposed method | | | | | | | | | | | | |
|---|---|---|---|---|---|---|---|---|---|---|---|---|---|
| Device/Method | TCH | EHX | DG1 | HE1 | HE2 | VE1 | DG2 | HE3 | VE2 | DG3 | HE4 | KKA | S2A |

| Algorithm | Aux | | 458 | | 458-II | | KTV | | S2A |
|---|---|---|---|---|---|---|---|---|---|
| Accompaniment | Guitar/Other | KB | Fixed interval from | | Fixed interval from | | MIDI | | MIDI |
| Derivation | | | lead vocal | | lead with exceptions | | | | |
| Vocoded, Pitch- | Usually Vocoded or Pitch-Shifted except for HE1~3 | | | | | | Re-Synthesized | | |
| Shifted | | | | | | | | | |
| Re-synthesized | | | | | | | | | |
| Synchronization | Manual | | Not Applicable | | Not Applicable | | Manual | | Auto |
| Dissonance/ | Min | | Common, | | Common, | | None | Min | Almost |
| ‘wrong’ notes | | | Type-1 | | Type-2 | | | | none |
| Musical Ability | Guitar/Keyboard | Pro | Pro | Min | Pro | Min | Pro | Synch | None |
| or Understanding | | | | | | | | | |

Other comments
Algorithm:
Aux: Auxiliary input of harmony information
458: Blind fixed-interval (usually 4^{th}, 5^{th} or 8^{ve}) apart from lead vocal
458-II: 458 but avoids Type1 clashes & allows 3^{rd} intervals
KTV: Harmony from score/MIDI
S2A: Harmony from score/MIDI with automatic alignment
Types of dissonance:
Type1: key
Type2: chord
Device/Method:
TCH: TC-Helicon Harmony-G
EHX: EHX Voicebox
DG1: Digitech Vocalist Live (with guitar)
DG2: Digitech Vocalist Live (key preset, in 5^{th}s)
DG3: Digitech Vocalist Live (key preset, in 3^{rd}s)
HE1: Antares HE (Chord by MIDI controller)
HE2: Antares HE (Fixed Interval Mode)
HE3: Antares HE (Scale Interval Mode)
HE4: Antares HE (Chord by MIDI track)
VE1: Boss VE-20 (in 5^{th}s)
VE2: Boss VE-20 (in 3^{rd}s)
KKA: Kageyama's Karaoke Apparatus
S2A: Proposed Method

Pitch Interpretation

Pitch Derivation

In an embodiment, primary pitch derivation may be performed by means of autocorrelation. In other embodiments, other methods may be used for primary pitch derivation. This stage also serves as the preliminary Voiced/Unvoiced (V/U) discriminator since segments with undefined pitch may be identified as unvoiced segments at this point.

V/U Correction and Octave Correction

Voiced/Unvoiced correction may be performed next to correct transients of unvoiced misinterpretations in voiced speech (VUV) and vice-versa (UVU). Voiced vocals may be produced when the vocal cords vibrate during the pronunciation of a phoneme. Unvoiced signals, by contrast, do not entail the use of the vocal cords.

VUV errors may have to be corrected before UVU ones to preserve the accuracy of the transition locations. During which, the pitch data at the unvoiced transients have to be interpolated. Linear interpolation is found to be more effective than cubic-spline interpolation, which is commonly considered to be more natural. This stage should be performed before any octave correction is carried out. Octave correction is then performed using a similar method to identify and correct any octave transients.

Translation to Logarithmic MIDI Note-Number Scale

Translation to the MIDI Note-Number Scale is then performed using the formula:

$${n}_{midi - scale} = 9 + ( 12 {log}_{2} ( {f}_{Hz} \times \frac{32}{440} ) ) \qquad ( 1 )$$

where f_{Hz} is frequency in Hz.

Unlike the MIDI Note Numbers which are discrete, however, the translated pitch values are unrounded and left continuous.

Estimation of Overall Tuning Drift

Perfect pitch refers to the ability of a person to remember and identify or sing a pitch without the need of a reference pitch. This is an ability that comes to very few people and even amongst the most professional singers, few have this ability. Thus, there often is a significant discrepancy between the actual overall average tuning of a singer and the corresponding key especially when he or she is singing without a reference pitch.

The overall tuning drift is initially estimated by taking the ‘circular average’ of the decimal parts of the voiced pitch.

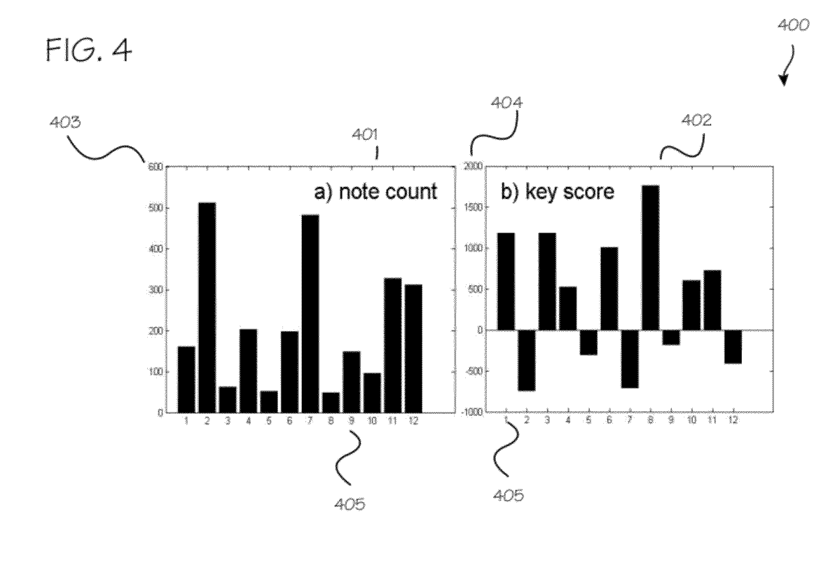

FIG. 4 is a chart of Key and Note Values Determination in accordance with an embodiment.

Chart 401 is the note count 403 and chart 402 is the key score 404.

The overall tuning drift is subtracted from each note value, and the result is rounded to establish the initial note values.

The frequency of occurrence is tabulated for each note (figure a), where octaves of the same note are considered to be the same note. Each note is weighted differently for each key and the weighted sum of all notes is established (figure b) for each of the twelve possible musical keys 405. In this way, the most probable song key is established.

Correction of Accidentals

In an embodiment, accidentals indicate if a note used is common in the key of the particular song. Occasionally, a song might use notes outside its native key, but this is rare for most commercial styles. At this stage, it is assumed that all notes keep within the key, and notes that were previously rounded to accidental notes are further rounded to the next nearest note within the key. It is recommended that this stage be omitted for styles such as jazz, where accidentals may be inconsistent. The key weightings used may have to be modified for other scales such as minor and blues.

Rule-Based Transient Segment Correction

In an embodiment, the pitch trace is almost established, with the exception of several transient segments. These transient segments should not be disregarded because of their contribution to misalignments that account for distortions in the final synthesized vocals. While they are more often intended to take the pitch of sustained segments just before or after the transient, with the split point defining the point of transition between notes, they may occasionally also be intended to take the pitch of the sustained mean or median of the transient. In the case of the former, the precise interpretation of the point of singer-intended transition is important for the proper alignment and segmentation of the voice, and ultimately the quality of the synthesized vocal harmony.

The transient segments are first identified based on lengths. Extremely short spikes of usually one or two frame-lengths are identified and removed. Nodal cues are extracted from pitch and amplitude envelope gradients as well as pitch and amplitude envelope peaks.

Finally, rules are established by a human expert in the field of music systems engineering in a systemic ‘node and determinant approach’. Determinants are drawn from geometric cues such as pitch boundary, the states of the trailing and preceding segments and the pitch, amplitude and temporal proximity of each point to each boundary. Rules are then established by mapping the state of the determinants to the established nodes. New nodal points (exceptions), and corresponding determinants, are allowed in overlapping intersections.

Pitch Alignment

The pitch trace for the lead melody is first plot by referring to the notation information in the MIDI file. The pitch trace of the actual lead vocals is automatically transposed to match the key of that of the MIDI file.

The two pitch traces are then aligned using the Dynamic Time Warping method. Each point on a pitch trace is first compared with each point in the other pitch trace in the plotting of an L_{Sung} by L_{midi} matrix, with each cell containing the difference between both pitches. A perfect match would hence be represented by 0, and the greater the distance the value is away from zero, the greater the mismatch.

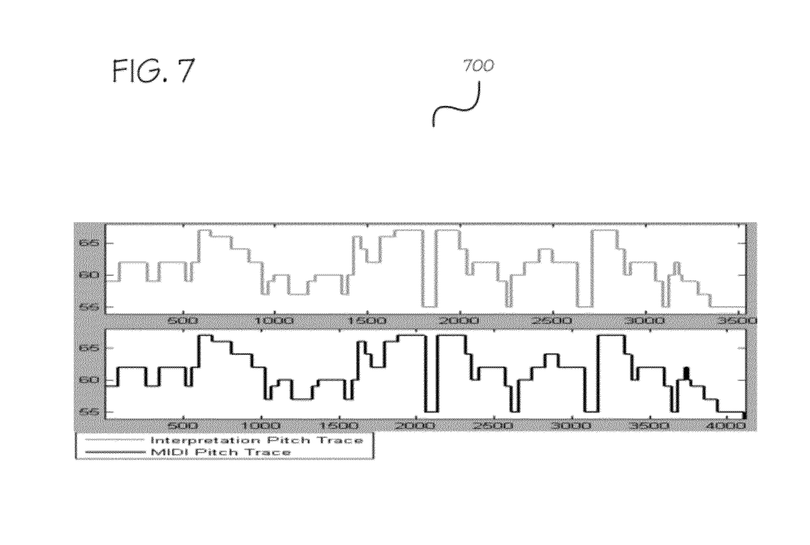

Next, the cost of traversal from each point on the matrix to the destination point on the matrix (top-right corner in FIG. 7) is computed. Finally, the matrix is traversed from the starting point (bottom-left corner) to the destination point, by choosing the adjacent point with the lowest cost of traversal.

The path of traversal computed describes the alignment between the MIDI and sung pitch traces.

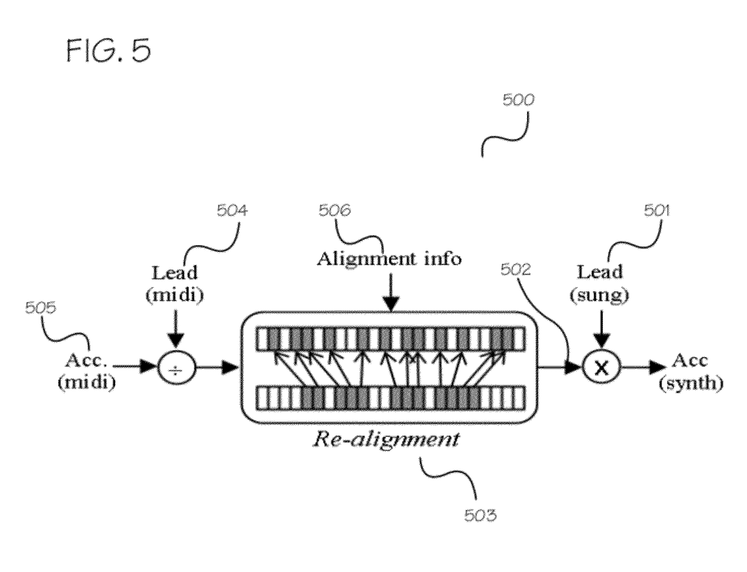

FIG. 5 is a diagram of re-synthesis.

FIG. 5 describes the method of re-synthesis 500 used. A high quality speech synthesizer is used in the re-synthesis of the singing voice. The lead vocal input 501 is analyzed and re-synthesized according to the synchronized pitch-interval vector 502 obtained after the re-alignment stage 503.

The pre-synchronized pitch interval vector is derived by finding the interval between the lead midi input 504 and the accompaniment input 505. Alignment info 506 is derived from the output of the alignment stage 102. The accompaniment pitch trace is passed to the synthesizer stage.

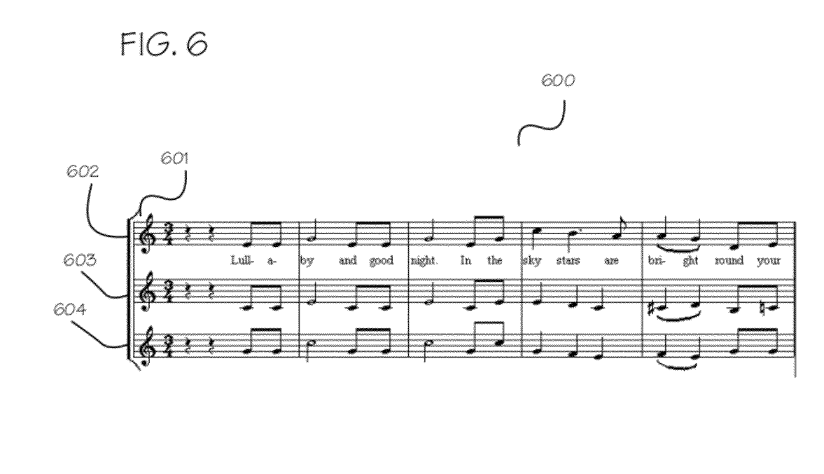

FIG. 6 is a first stanza of the contents of the MIDI sequence.

FIG. 6 shows the first stanza 601 of the contents of the MIDI sequence of the song Brahms' Cradlesong in the transcribed format of a music score. This arrangement the song is for three-part harmony (one lead 602 plus two accompaniments 603, 604) while the arrangement used for second song (not shown) is sequenced for two voices (one lead plus one accompaniment).

FIG. 7 compares the midi pitch trace with that of the interpretation of the sung vocal lead.

The y-coordinate similarity is an approximate indication of the effectiveness of the interpretation algorithm.

In this figure, the pitch trace of the Sung Vocal Lead for Brahms' Cradlesong is plotted against the MIDI Pitch Trace of the same (notice the difference in meters).

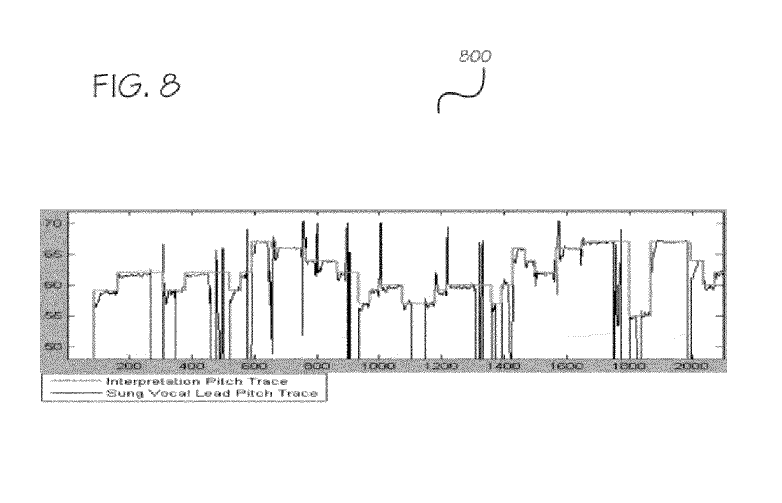

FIG. 8 shows the pitch trace raw and after the interpretation stage.

In this Figure, the pitch trace of the Sung Vocal Lead for Brahms' Cradlesong is plotted against its Interpretation Pitch Trace.

The x-coordinate similarity is an approximate indication of the effectiveness of the alignment algorithm.

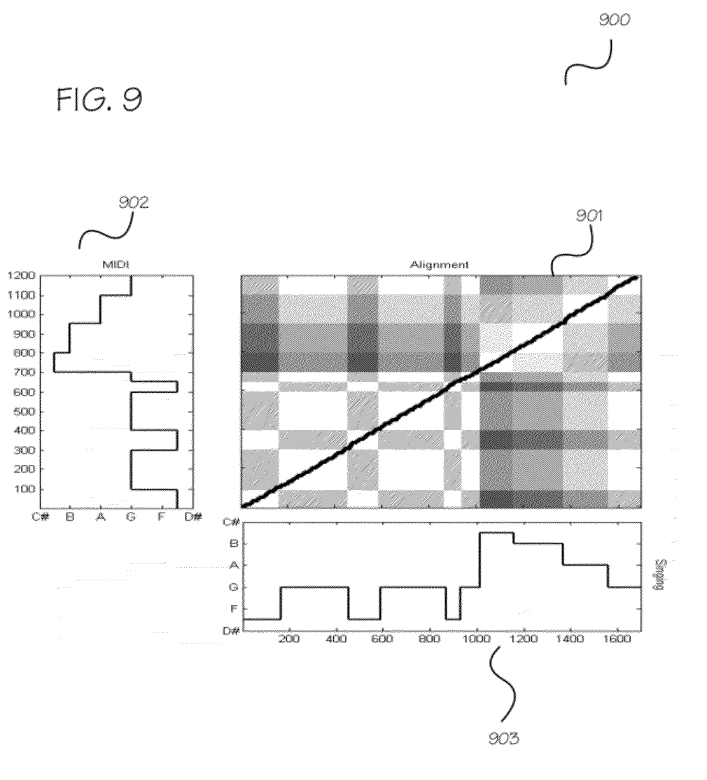

FIG. 9 shows an alignment of the Interpreted and MIDI pitch traces.

The matrix 901 in FIG. 9 shows an L_{Sung} by L_{midi} matrix for pitch trace alignment. The plot 902 on the left represents the MIDI pitch trace while the plot 903 at the bottom represents the pitch trace of the sung vocal lead after being refined by the interpretation algorithm. In the matrix itself, the brightness of the cells represent a better match, where points along the MIDI trace are more similar to those along the actual vocals trace. Black cells denote a complete mismatch, or where there are unvoiced or silent segments along the actual vocals. The white line that traverses the matrix represents the optimum low-cost short-path trajectory, which is the alignment information (mapping function).

The Re-synthesis Stage and Final Outputs

The 458 experiment uses transpositions a perfect 4^{th}, a perfect 5^{th} or an 8^{ve} away from the lead vocals as the harmony line(s). The KTV experiment emulates the effect of a singer singing slightly off-timing into a karaoke harmony device using the KTV (KKA) method. The spectrograms of the results are compared against that of the human voice. Listening tests are carried out to compare the 3 results.

FIG. 10 is a comparison of spectrogram plots.

FIG. 10 compares the spectrogram plots 1000 for the harmonization of the song “Twinkle Twinkle Little Star” using the 3 methods against that of the human voice. The last stanza is compared here, “How I wonder what you are”.

In the spectrograms, ‘A’ identifies the lead line and ‘B’ identifies the accompaniment line. ‘C’ cites an example of the undesirable effect of “perfect harmonic alignment” with the 458 method. It is undesirable for, as explained in 1, perfect phase alignment does not produce perceived frequency or amplitude variations which are musically appealing. Here, the 3rd harmonic of the lead aligns almost perfectly with the 2nd harmonic of the accompaniment when the accompaniment is derived by transposing the fundamental up a perfect 5th. ‘D1’ identifies regions of dissonance or potential dissonance due to key or chord ignorance. ‘D2’ identifies regions of dissonance or potential dissonance due to timing accuracies. Finally, ‘E’ indicates incorrect points of transition due to misalignment.

The ‘+’s, and ‘−’s compliment ‘D1’ and ‘D2’ by indicating regions of consonance or coincidental consonance, and dissonance respectively. Coincidental consonance refers to less common regions where the alignment is completely off but consonance is observed even though unplanned. At indications of dissonance, the ‘−’s coincide with consonant locations.

It may also be observed that of the three, the S2A spectrogram is most identical to the human voice.

Subjective Listening Tests

The songs “Brahms’ Cradlesong” and “Twinkle Twinkle Little Star” were synthesized using the 3 methods. For the first song, 2 accompaniments are synthesized; for the second song, 1 accompaniment is synthesized.

In an embodiment, spectrograms of vocal harmony synthesized using (a) the 458 method, (b) the KTV method and (c) the S2A method (the proposed method) against that of (d) actual human vocals.

For synthesis using the 458 methods, a perfect 4th below and an octave above were chosen for the first song and a perfect 5th above was chosen for the 2nd song. For synthesis using the KTV method, results are expected to differ greatly depending on the timing drift of the singer and it is difficult to identify a singer with the generic sense of timing. As such, a singer slightly (up to about 0.3 sec) out of timing is emulated as an example. This is done by setting loose alignment criteria.

Vocal Experts' Opinion

In the first test, eleven vocal experts were tasked to listen to the six songs and evaluate them in terms of consonance (harmony) and smoothness of transition. These two characteristics were explicitly specified because of the following reasons:

The 458 method, deriving the accompaniment by transposing the lead vocals by a fixed interval throughout the song, is expected to score well in terms of smoothness of transition but suffer in terms of consonance.

The KTV method, on the other hand, deriving its accompaniment from midi whilst relying on manual synchronization, is expected to score better in terms of consonance but poorly in terms of transition. However, it is anticipated that poor location of transition can have a negative effect on its score in consonance. Table 2 shows their average ratings for each of the songs on a scale of 1 to 5.

TABLE 2
Results of Subjective Listening Tests by Vocal Experts for
(a) Consonance and harmony
Consonance/Harmony

| | 458 | KTV | S2A |
|---|---|---|---|
| Brahms' | 2.8 | 1.5 | 4.4 |
| Cradlesong | | | |
| Twinkle Twinkle\| | 3.8 | 1.8 | 4.6 |
| Little Star | | | |
| | 3.3/5.0 | 1.6/5.0 | 4.5/5.0 |
| | (66.4%) | (32.7%) | (90.0%) |

(b) Smoothness of transition
Smoothness of Transition

| | 458 | KTV | S2A |
|---|---|---|---|
| Brahms' | 2.4 | 1.4 | 2.8 |
| Cradlesong | | | |
| Twinkle Twinkle | 2.5 | 1.8 | 3.4 |
| Little Star | | | |
| | 2.5/5.0 | 1.6/5.0 | 3.1/5.0 |
| | (49.1%) | (31.8%) | (61.8%) |

The S2A method performs best in terms of both consonance and smoothness of transition. This result verifies the effectiveness of the method. It was not expected for the proposed method to outperform the 458 method in terms of transitional smoothness. This result may be attributed to the unnatural effect produced by the 458 method's synchronized transitions.

Non-Experts' Opinion

In the second test, twelve non-experts were tasked to listen to the six songs. Because non-experts are not expected to be as attentive to aural detail, they are tasked to rate each song on a scale of 1 to 10 on how pleasant and natural they thought each song sounded. Table 3 lists their ratings on a scale of 1 to 10.

TABLE 3
Results of Subjective Listening Tests by Non-Experts
Pleasant/Natural Sounding

| | 458 | KTV | S2A |
|---|---|---|---|
| Brahms' | 6.7 | 6 | 8.25 |
| Cradlesong | | | |
| Twinkle Twinkle | 5.5 | 4.7 | 5.8 |
| Little Star | | | |
| | 6.1/10 | 5.3/10 | 7.0/10 |
| | (60.8%) | (53.3%) | (70.0%) |

The result once again verifies the effectiveness of the proposed method, although it may not be as obvious this time due to the lack of attention to aural detail of the non-experts.

The score for the 458 method here might be slightly biased towards positive because certain clashes/dissonance might not be obvious in the absence of a backing track.

The various embodiments provide a new method of automatic vocal harmony that, unlike existing methods, is suitable for singers without a good sense of rhythm yet does not sacrifice the quality of consonance. Spectrograms as well as subjective listening tests by field experts and non-experts indicate the successfulness of the proposed method in achieving a better level of perceived harmonic consonance, transitional smoothness, as well as overall naturalness and pleasantness.

1. A method for harmonizing vocal signals, the method comprising:
receiving an input vocal signal;
identifying a pitch trace of the vocal signal;
aligning a harmonization interval vector to the pitch trace of the vocal input signal to form an aligned harmonization pitch trace; and
synthesizing harmonization vocals according to the aligned harmonization pitch trace.

2. The method according to claim 1, wherein aligning the pitch trace of harmonization intervals to the pitch trace of the vocal signals comprises:
aligning a reference pitch trace to the pitch trace of the input vocal signal to form a mapping function; and
aligning a number of accompaniment pitch intervals to the input vocal signal according to the mapping function to form a number of synchronized accompaniment voices.

3. The method according to claim 2, wherein synthesizing the harmonization vocals according to the aligned harmonization intervals comprises:
synthesizing the number of synchronized accompaniment voices according to the pitch trace of the input vocal signal.

4. The method according to claim 1, wherein the number of accompaniment pitch traces are an interval between the reference pitch trace and the number of accompaniment pitch traces.

5. The method according to claim 1, wherein the reference pitch trace is from a MIDI signal.

6. The method according to claim 1, wherein the number of accompaniment pitch traces are from MIDI signals.

7. The method according to claim 1, wherein identifying the pitch trace of the vocal signals comprises:
identifying an autocorrelation of the vocal signals.

8. The method according to claim 1, wherein identifying the pitch trace of the vocal signals comprises:
correcting unvoiced speech and voiced speech misinterpretations for the pitch trace.

9. The method according to claim 1, wherein identifying the pitch trace of the vocal signals comprises:
translating to a MIDI Note-Number Scale using the formula:
$${n}_{midi - scale} = 9 + ( 12 {log}_{2} ( {f}_{Hz} \times \frac{32}{440} ) )$$
where f_{Hz} is frequency in Hz.

10. The method according to claim 1, wherein identifying the pitch trace of the vocal signals comprises:
estimating an overall tuning drift for the pitch trace.

11. The method according to claim 1, wherein identifying the pitch trace of the vocal signals comprises:
identifying a frequency of occurrence for each note of the pitch trace;
weighting each note differently for each possible key; and
identifying a probable key for each note based on the weighted notes.

12. The method according to claim 1, wherein identifying the pitch trace of the vocal signals comprises:
adjusting an accidental note of the pitch trace to a nearest note within a key of the pitch trace.

13. A harmony synthesizer for harmonizing vocal signals, the harmony synthesizer comprising:
an interpretation unit configured to receive an input of the vocal signals and identifying a pitch trace of the vocal signals;
an alignment unit configured to align a pitch trace of harmonization signals to the pitch trace of the vocal signals; and
a speech synthesizer configured to synthesize the vocal signals to the harmonization signals.

14. The harmony synthesizer according to claim 13, wherein the alignment unit is further configured to:
align a reference pitch trace to the pitch trace of the vocal signals to form a mapping function; and
align a number of accompaniment pitch traces to the mapping function to form a number of synchronized accompaniment pitch traces.

15. The harmony synthesizer according to claim 13, wherein the speech synthesizer is further configured to:
synthesizing the harmonization vocals according to the aligned harmonization pitch traces.

16. The harmony synthesizer according to claim 13, wherein the number of accompaniment pitch traces are interval pitch traces based on a relationship between the reference pitch trace and the number of accompaniment pitch traces.

17. The harmony synthesizer according to claim 13, wherein the reference pitch trace is from a MIDI signal.

18. The harmony synthesizer according to claim 13, wherein the number of accompaniment pitch traces are from MIDI signals.

19. The harmony synthesizer according to claim 13, wherein the interpretation unit is further configured to:
identify an autocorrelation of the vocal signals.

20. The harmony synthesizer according to claim 13, wherein the interpretation unit is further configured to:
correct voiced and unvoiced speech misinterpretations for the pitch trace.
